(19) United States
(12) Patent Application Publication
(10) Pub. No.: US 2024/0227259 A1
(43) Pub. Date: Jul. 11, 2024

(54) A Footwear Moulding System for Direct Injection Production of Footwear and a Method for Manufacturing Footwear

(71) Applicant: ECCO SKO A/S, Bredebro (DK)

(72) Inventor: FRANK JENSEN, Bredebro (DK)

(21) Appl. No.: 18/559,301

(22) PCT Filed: May 6, 2022
(86) PCT No.: PCT/DK2022/050093

§ 371 Date: Nov. 6, 2023

(30) Foreign Application Priority Data
May 7, 2021 (DK) PA202170217

(51) Int. Cl. B29C 45/14; B29C 45/26; B29D 35/00; B29D 35/06; B29D 35/12; B29L 31/50

(52) U.S. Cl. CPC B29C 45/14065; B29C 45/26; B29D 35/0036; B29D 35/062; B29D 35/122; B29D 35/128; B29C 2045/14155; B29L 2031/504

(57) ABSTRACT

A footwear molding system for direct injection production of footwear. The system includes an injection mold and a mold closing member. The mold closing member includes at least one vacuum channel. The at least one vacuum channel is connected directly or indirectly to at least one vacuum opening on the surface of the mold closing member. The mold closing member is configured for positioning at least part of a footwear upper during at least part of a direct injection production process. The at least part of a footwear upper being at least partly adhered to the mold closing member by vacuum effected by the at least one vacuum opening.

### FIELD OF THE INVENTION

The invention relates to a moulding system according to claim 1.

Furthermore, the invention relates to a method for manufacturing a footwear and even further, the invention relates to a mould closing member for direct injection production of footwear.

### BACKGROUND OF THE INVENTION

It is known in the art to manufacture footwear by means of direct injection of the sole to the upper.

The direct injection process (DIP) is advantageous in many ways as the manufactured footwear may be produced to possess both flexibility and strength at the same time.

A challenge in relation to such a direct injection process is that the method of manufacture requires at least a partly fixation of the footwear upper for an optimal moulding process and footwear manufacturing.

### SUMMARY OF THE INVENTION

The invention relates to a footwear moulding system for direct injection production of footwear, said moulding system comprising
an injection mould,
a mould closing member, wherein the mould closing member comprises at least one vacuum channel and wherein the at least one vacuum channel is connected directly or indirectly to at least one vacuum opening on the surface of the mould closing member,
wherein said mould closing member is configured for positioning at least part of a footwear upper during at least part of a direct injection production process, said at least part of a footwear upper being at least partly adhered to the mould closing member by vacuum effected by said at least one vacuum opening.

Hereby, a flexible moulding system for direct injection of footwear is achieved.

The present invention makes it possible to attach an article e.g. a piece of footwear upper or a part of a footwear upper to a footwear sole in the same manufacturing process and thereby minimizing handling processes such as gluing and/or stitching.

Vacuum keeps the position of the article during the direct injection process and in that way a conventional last and lasting process may not be necessary. Thus, by fixating the footwear upper to e.g. a last initially or prior to the direct injection process minimises the use and investment in machine lasts.

Further, the present invention simplifies the process of making footwear and has less handling compared to the conventional way. Multiple upper designs can be used during the manufacturing process and thereby reducing cost and handling.

Furthermore, a precise positioning of e.g. footwear upper parts may be facilitated by the present invention.

According to embodiments of the invention, the mould closing member is a last.

According to embodiments of the invention, the mould closing member is a dummy last.

By configuring the mould closing member as a dummy last, the moulding system may be applied in a wider variety of uses and applications, for example in connection with manufacturing of sandals, where a dummy last may serve the purpose of keeping the injection material in the form during the manufacturing process.

According to embodiments of the invention, the mould closing member, e.g. the dummy last, may be a loose or separate part that can be applied to the mould prior to the direct injection process or the mould closing member may also be a part of the mould.

According to embodiments of the invention, the mould closing member comprises at least one part of 3D printed material.

According to embodiments of the invention, the injection mould comprises at least two side moulds and at least one bottom mould.

According to embodiments of the invention, the at least one vacuum channel is branched out in multiple sub-channels and wherein the sub-channels are connected to vacuum openings on the surface of the mould closing member.

Hereby, an efficient and evenly distributed supply of vacuum can be obtained throughout the mould closing member.

According to embodiments of the invention, the surface of the mould closing member comprises sub-surfaces and wherein the sub-channels are connected to vacuum openings on said sub-surfaces.

Hereby, the vacuum supply can be controlled and directed to specific and/or selected locations of the mould closing member, where to vacuum supply is to be used. An example hereof may be subchannels solely supplying the upper side of the mould closing member for adherence of a footwear upper. Another example may be a vacuum supply of the sole side is maintained for adherence of e.g. a footbed.

According to embodiments of the invention, each of the sub-channel is connected to vacuum openings allocated to respective of said sub-surfaces.

Hereby, the vacuum channels and vacuum openings may be directed to specific locations and thus providing various individually controllable zones. The concentration of sub-channels and vacuum openings may vary between different sub-surfaces of the mould closing member. An example could be a higher concentration on the toe surface side and/or the heel surface side, where a toe cap and/or a heel cap of a more rigid material may be applied and may require more vacuum openings or a higher vacuum supply, e.g. for effecting a larger suction effect, for adhering the toe and/or the heel cap during manufacturing of the footwear.

According to embodiments of the invention, the mould closing member comprises vacuum openings on the lateral side, medial side and/or ground facing surface side.

According to embodiments of the invention, the at least one vacuum channel is controllable.

Controllable in this regard should generally be understood as an opening and closing of the vacuum supply. However, controllable may also be understood as controlling different sub-surfaces or vacuum zones differently according to various applications and embodiments of the invention.

Moreover, it should be understood that the vacuum channel is connected to at least one vacuum supply e.g. a vacuum pump.

It is a further possibility that the vacuum supply may be controlled by e.g. adjusting the vacuum level, by switching between two or more levels, etc.

According to embodiments of the invention, the mould closing member comprises at least 2 vacuum channels, such as at least 3 vacuum channels, such as at least 4 vacuum channels, such as at least 5 vacuum channels, such as between 1-10 vacuum channels.

It is noted that it is possible that more than 10 vacuum channels may be comprised in the mould closing member.

According to embodiments of the invention, the footwear moulding system further comprises injection moulding equipment for performing direct injection moulding of a sole part in said injection mould.

According to embodiments of the invention, the direct injection production comprises injection of injection material.

According to embodiments of the invention, the direct injection material may be polyurethane (PU), thermoplastic polyurethane (TPU), polyvinyl chloride (PVC) or thermoplastic rubber (TR).

It is noted that other materials may be suitable as well.

According to embodiments of the invention, the diameter of the vacuum opening is smaller than the diameter of the vacuum channel.

According to embodiments of the invention, the vacuum channel has an inside diameter of at least 5 mm.

According to embodiments of the invention, the vacuum opening has an inside diameter of at least 0.1 mm.

The inside diameter of the vacuum opening may vary according to different applications of the vacuum openings, e.g. if smaller parts of an upper is to be fixed to the mould closing member by the vacuum openings, it may be sufficient with a small vacuum opening compared to fixing larger and/or thicker parts of an upper to the mould closing member.

The mould closing member may also comprise various sections with vacuum openings of a particular inside diameter and other section(s) with vacuum openings of another inside diameter and can also be a mix of various inside diameters.

The inside diameter of the vacuum opening may be between 0.1 mm-2 cm, such as 0.5 mm-1.5 cm, such as 1 mm-1.5 cm, such as 1.5 mm-1 cm, such as 2 mm-0.5 cm, such as 5 mm-1 cm.

It is noted that when referring to the inside diameter of the vacuum openings or the inside diameter of the vacuum channels, it is presupposed that the vacuum openings or the vacuum channels have an inner circular form. However, it should be understood that other forms may be applied, in which cases it will be understood that reference to the inside diameter may be understood as referring to a comparable circular form, e.g. a tube or pipe having an effective area for applying vacuum as the actual e.g. tube or pipe having the particular non-circular form.

According to embodiments of the invention, the system comprises at least one piece of protection foil to cooperate with one or more of said at least one vacuum opening.

According to embodiments of the invention, the at least one piece of protection foil may be configured for being applied at one side of at least one footwear part and wherein the opposite part of the footwear part is at least partly adhered to the mould closing member by vacuum effected by said at least one vacuum opening.

Hereby, it may be achieved that the at least one piece of protection foil may serve to protect the footwear part from markings from the vacuum openings, e.g. since the vacuum will be evened out along the area of the protection foil, in case the footwear upper is permeable, and/or since the protection foil will serve as a strengthening means to the footwear upper during vacuum.

It is noted that the at least one piece of protection foil may be adhered to the at least one footwear part by an adhesive and/or it may be adhered due to vacuum. Other manners of adhering may be possible.

According to embodiments of the invention, said at least one footwear part may be a footwear upper part, a footwear insert, a sock, an insock, an insole and/or a lining.

The invention further relates to a method for manufacturing a footwear, whereby a footwear moulding system according to embodiments of the invention is applied for direct injection moulding of a sole part.

The invention further relates to a method for manufacturing a footwear, said method comprising the steps of providing a moulding system comprising
an injection mould, and
a mould closing member,
wherein the mould closing member comprises at least one vacuum channel and wherein the at least one vacuum channel is connected directly or indirectly to at least one vacuum opening on the surface of the mould closing member,
wherein said method further comprises the steps of
applying a source of vacuum to said at least one vacuum channel,
positioning at least part of a footwear upper on said mould closing member, said at least part of a footwear upper being at least partly held in place by said vacuum,
positioning said mould closing member with said at least part of a footwear upper in relation to said injection mould,
closing said injection mould to form a mould cavity,
injecting direct injection material into said mould cavity, said mould cavity defining a sole and
opening said injection mould upon curing for removal of the sole with said at least part of a footwear upper attached to the sole.

It is noted that the sole being defined by the mould cavity and being formed by injection moulding may be e.g. a midsole, an outsole or any other kinds of soles/sole parts.

According to embodiments of the invention, the method may further comprise positioning a further part of a footwear such as e.g. an insole, part of an insole, etc. on said mould closing member, said further part of a footwear being at least partly held in place by said vacuum.

According to embodiments of the invention, the at least part of a footwear upper may comprise two or more individual pieces of footwear parts, e.g. footwear upper parts, wherein said two or more individual pieces of footwear parts are positioned and at least partly held in place by said vacuum on said mould closing member.

According to embodiments of the invention, said two or more individual pieces of footwear parts, e.g. footwear upper parts, may subsequent to removal of the sole with said at least part of a footwear upper, i.e. said two or more individual pieces of footwear parts attached to the sole be further processed to form part of the upper of the footwear.

According to embodiments of the invention, said two or more individual pieces of footwear parts, e.g. footwear upper parts, may subsequent to removal of the sole with said two or more individual pieces of footwear parts attached be processed by being connected along at least part of adjoining edges.

According to embodiments of the invention, the two or more individual pieces of footwear parts are being connected along at least part of adjoining edges by sewing, gluing and/or other means.

It is noted that said adjoining edges may be overlapping, meeting end to end or configured in any other manner.

According to embodiments of the invention, the method comprises applying a protection foil.

According to embodiments of the invention, the method comprises removal of a protection foil.

According to embodiments of the invention, said protection foil may be configured for being applied at one side of at least one footwear part and wherein the opposite part of the footwear part is at least partly adhered to the mould closing member by vacuum effected by said at least one vacuum opening.

Hereby, it may be achieved that the at least one piece of protection foil may serve to protect the footwear part from markings from the vacuum openings, e.g. since the vacuum will be evened out along the area of the protection foil, in case the footwear upper is permeable, and/or since the protection foil will serve as a strengthening means to the footwear upper during vacuum. In particular, it is noted that in case e.g. two or more individual pieces of footwear parts are involved, the protection foil may even further serve the purpose of maintaining the mutual positions of these footwear parts during processing, e.g. in order to assure that adjoining edges are not unintentionally moved in relation to each other during e.g. lasting, closing of the mould, moulding, etc.

According to embodiments of the invention, the footwear comprises a footwear upper and wherein the footwear upper comprises at least one layer of material.

According to embodiments of the invention, the at least one layer of material comprises leather.

According to embodiments of the invention, the at least one layer of material may comprise textile, synthetic material, etc.

According to embodiments of the invention, the footwear upper comprises a leather flesh side and wherein the leather flesh side is attached to the sole side surface.

An advantage of a footwear upper comprising a leather flesh side attached to the sole side surface is that the process of roughing, for the adherence of the footwear upper to the sole, is diminished or absent. Hereby, it is possible to use all the top grain leather for the upper and obtain an effective and maximal utilization of the leather.

The process of roughing should be understood as a scratching or loosening process of the leather fibers to ensure that the material binds sufficiently.

According to embodiments of the invention, the footwear comprises a footbed.

According to embodiments of the invention, the footbed comprises a sock, cork, leather, foam, gasket and/or PU.

According to embodiments of the invention, applying a source of vacuum to said at least one vacuum channel is maintained in the steps of “lasting upper”, “positioning in mould” and “closing mould”.

According to embodiments of the invention, applying a source of vacuum to said at least one vacuum channel is further maintained in the step of “injecting material”.

According to embodiments of the invention, applying a source of vacuum mediates a pressure that is lower than the local atmospheric pressure.

According to embodiments of the invention, the pressure is in a range of 0.1-0.9 bar, such as 0.2-0.6 bar.

According to embodiments of the invention, all vacuum openings are engaged.

Engaged should here be understood as all the vacuum openings are covered e.g. for fixing an upper to the last and thus, no openings are “free” e.g. for passively diffusion.

According to embodiments of the invention, curing is less than 5 min., such as less than 4 min., such as between 5-1 min., such as between 4-2 min., such as between 4-3 min.

The invention further relates to a mould closing member for direct injection production of footwear, wherein said mould closing member comprises at least one vacuum channel and wherein the at least one vacuum channel is connected directly or indirectly to at least one vacuum opening on the surface of the mould closing member, wherein said mould closing member is configured for positioning at least part of a footwear upper during at least part of a direct injection production process, said at least part of a footwear upper being at least partly adhered to the mould closing member by vacuum effected by said at least one vacuum opening.

Hereby, flexible moulding of footwear by direct injection may be achieved, wherein various designs may be applied, e.g. by positioning at least part of a footwear upper according to a specific design during at least part of a direct injection production process to the mould closing member.

According to embodiments of the invention, the mould closing member is a last.

According to embodiments of the invention, the mould closing member is a dummy last.

According to embodiments of the invention, the mould closing member comprises at least one part of 3D printed material.

According to embodiments of the invention, the at least one vacuum channel is branched out in multiple sub-channels and wherein the sub-channels are connected to vacuum openings on the surface of the mould closing member.

Hereby, an efficient and evenly distributed supply of vacuum can be obtained throughout the mould closing member.

According to embodiments of the invention, the surface of the mould closing member comprises sub-surfaces and wherein the sub-channels are connected to vacuum openings on said sub-surfaces.

Hereby, the vacuum supply can be controlled and directed to specific and/or selected locations of the mould closing member, where to vacuum supply is to be used. An example hereof may be subchannels solely supplying the upper side of the mould closing member for adherence of a footwear upper. Another example may be a vacuum supply of the sole side is maintained for adherence of e.g. a footbed.

According to embodiments of the invention, each of the sub-channel is connected to vacuum openings allocated to respective of said sub-surfaces.

Hereby, the vacuum channels and vacuum openings may be directed to specific locations and thus providing various individually controllable zones. The concentration of sub-channels and vacuum openings may vary between different sub-surfaces of the mould closing member. An example could be a higher concentration on the toe surface side and/or the heel surface side, where a toe cap and/or a heel cap of a more rigid material may be applied and may require more vacuum openings or a higher vacuum supply for adhering the toe and/or the heel cap during manufacturing of the footwear.

According to embodiments of the invention, the mould closing member comprises vacuum openings on the lateral side, medial side and/or ground facing surface side.

According to embodiments of the invention, the at least one vacuum channel is controllable.

Controllable in this regard should generally be understood as an opening and closing of the vacuum supply. However, controllable may also be understood as controlling different sub-surfaces or vacuum zones differently according to various applications and embodiments of the invention.

Moreover, it should be understood that the vacuum channel is connected to at least one vacuum supply e.g. a vacuum pump.

It is a further possibility that the vacuum supply may be controlled by e.g. adjusting the vacuum level, by switching between two or more levels, etc.

According to embodiments of the invention, the mould closing member comprises at least 2 vacuum channels, such as at least 3 vacuum channels, such as at least 4 vacuum channels, such as at least 5 vacuum channels, such as between 1-10 vacuum channels.

According to embodiments of the invention, the diameter of the vacuum opening is smaller than the diameter of the vacuum channel.

According to embodiments of the invention, the vacuum channel has an inside diameter of at least 5 mm.

According to embodiments of the invention, the vacuum opening has an inside diameter of at least 0.1 mm.

### Footwear

The footwear according to embodiments of the invention may be any type of footwear such as a sneaker, sport's shoe, formal shoe, boot, lace up shoe, slip-ons, loafers, sandals, or any other type of footwear. Sandals should be understood as an open type of footwear, consisting of a sole held to the wearers foot by a strap or straps going over the instep and sometimes around the ankle. Sandals may also have a heel. Sandals vary in how much of the foot that is exposed, however, the common understanding is that a sandal leaves at least part of the foot exposed.

The sandals according to embodiments of the invention may be any type of sandals such as flip flops, sports sandals, everyday flats, dressy flats, slides, wedge sandals, gladiator sandals, thong sandals or any other type of sandal.

### Upper

The upper according to embodiments of the invention, may be of any material such as leather, natural leather, textile, reinforcing fabric, reconstructed fibers, woven or non-woven material based on natural or synthetic fibers or any other type of material.

Leather may be any type of leather such as full grain or top leather, corrected or embossed grain, split suede, nubuck sueded grain, reconstructed, reconstituted, bonded or fiber leather or any other type of leather. In principle, the leather can derive from any source, including bovine hide, horse hide, goat skin, sheep skin, camel skin, kangaroo, ostrich, snake, crocodile, pig hide or the like. “Bovine” as used herein means, with referral to the traditional taxonomic grouping, a group of animals including e.g. cattle, ox, yak etc.

### DIP/Sole

Direct injection process should be understood as the process of introducing a molten material into a cavity of a mold to achieve a desired shape. Further, the DIP process could be understood as the process of introducing a 2 part liquid chemical mix (e.g. PU) into a mould cavity, whereupon a chemical reaction takes place, solidifying the hitherto liquid into a single homogeneous solid or foam material. The process can be used for the production of outsole, a midsole, other sole parts or decorative details. During the process, a molten material, normally a polymer, is forced into the cavity of a mold. The process may be known as DIP or direct injection process and they may be used interchangeably.

The sole can be manufactured from any materiel such as e.g. thermoplastic rubber, injection molding resin (TPR), polyvinyl chloride (PVC), polyurethane (PU), ethylene vinyl acetate (EVA), thermoplastic polyurethane (TPU) and/or the like suitable for a direct injection process. The sole can also comprise several parts possibly manufactured from different materials. Such parts may be molded into the sole or may be attached to the sole by e.g. an adhesive or the like.

Unless otherwise noted in the present application, the meaning of DIP is to be understood as the process of integrating a sole with an upper or at least a part of an upper by and during a DIP process. Thus, single elements, e.g. pressure absorbers or sole parts may be DIP'ed in separate processes (without being attached to the sole) and then subsequently be inserted into the mold by means of which the sole or a part of the sole is to be molded and integrated with the upper or at least a part of the upper. The manufacturing process according to embodiments of the invention may be a manual process or may be an at least partly automatic process.

The sole part according to embodiments of the invention may be a midsole, outer sole, etc.

### Material Mould Closing Member

The mould closing member may be manufactured from a polymeric material, or a material comprising a polymer, where the side wall of the mould closing member may comprise a plurality of monomers that may be connected to each other via covalent bond. The polymeric material of the mould closing member may have a hardness that allows the mould closing member to resist permanent or temporary indentation during the use of the mould closing member.

The mould closing member may comprise a polymeric material having a Shore D value of between 50 and 100 or having a Shore D value of between 60 and 99 or having a shore D value of between 70 and 95. The polymeric material of the mould closing member may be constructed of a polymeric composition comprising a polymeric material having reinforcement materials such as carbon fibre, glass fibre, or other types of materials that may reinforce the mould closing member.

In one exemplary embodiment of the invention, the mould closing member may comprise a thermoplastic polymer. Alternatively, the mould closing member may comprise a thermoset material. Thus, the mould closing member may be produced by providing a polymeric material or a molten material in a molten state, where the curing or hardening of the material ensures that the material maintains its shape after the material has cured. Alternatively, the mould closing member may comprise photocurable polymers and/or resins, where a light source, such as a laser may cure the polymers and/or resin material causing the polymers and/or resin to solidify. The thermoset polymer may be irreversibly hardened by curing from a soft solid or a viscous liquid prepolymer or resin. Curing may be induced by heat or suitable radiation and may be promoted by high pressure or mixing with a catalyst. It results in chemical reactions that create extensive cross-linking between polymer chains to produce an infusible and/or insoluble polymer network.

In one exemplary embodiment of the invention, the mould closing member comprises at least one support structure extending from an internal surface of the mould closing member to an opposing internal surface of the mould closing member. The support structure may be in the form of one or more support beams that extend from one internal surface of the mould closing member towards an opposing and/or a second internal surface of the mould closing member. The support beam may be configured to transmit force from a first side wall of the mould closing member to a second side wall of the mould closing member, allowing the beam to provide a counterforce to a region of the mould closing member which is intended to receive an application of force.

The support structure may be in the form of a girder, crossbar, brace or any type of rigid and/or semi rigid structure which is capable of transferring force from one region of the inner surface of the mould closing member to another region of the inner surface of the mould closing member. In one embodiment the support structure may be a plurality of support structure elements, such as a frame, a grid of beams, a network of beams, or a lattice of beams that may extend from each inner surface to another inner surface of the mould closing member.

### 3D Manufacturing Mould Closing Member

In one exemplary embodiment of the invention, the mould closing member is formed by additive manufacturing. The additive manufacturing may be a process where a material is joined or solidified under computer control to create the mould closing member, where material is added together layer by layer, where liquid molecules or powder grains are being fused together, or where a layer of material is added on top of another layer of material in sequence. The additive manufacturing may be done by 3D printing the mould closing member for footwear production or any part of the mould closing member that can be manufactured along with the mould closing member. The term additive manufacturing may be replaced by the term 3D printing in the present disclosure. The additive manufacturing may be done by adding heat or radiation to a layer of material or a region of an item, where the heat and/or the radiation causes the material to cure and harden in the area of radiation.

In an embodiment of the invention, additive manufacturing materials, e.g. printing materials, utilized by said additive manufacturing, e.g. 3D printing, may comprise at least one selected from the list comprising polymers, resin photopolymers, ABS, PLA, ASA, nylon/nylon powder, PETG, metal/metal powder, plaster powder, HIPS, PET, PEEK, PVA, ULTEM, polyjet resin and/or ceramics and any combination thereof.

According to embodiments of the invention, the mould closing member and/or the vacuum channels and vacuum openings may be formed by additive manufacturing.

According to embodiments of the invention, the mould closing member may have been made out of metal, for example aluminium by e.g. CNC machinery.

Various exemplary embodiments and details are described hereinafter with reference to the figures when relevant. It should be noted that the figures may or may not be drawn to scale and the figures are only intended to facilitate the description of the embodiments.

### THE FIGURES

The invention will be explained in further detail below with reference to the figures of which

FIG. 1a-1b illustrate a moulding system for production of footwear in accordance with prior art,

FIG. 2a-2j show schematically illustrated basic direct injection moulds, seen in a cross-sectional view according to embodiments of the present invention,

FIG. 3a-3f show schematically illustrated mould closing members according to embodiments of the invention,

FIG. 4 shows a footwear or sole from above illustrating the locations of the medial ME and lateral LA positions on the footwear according to embodiments of the invention,

FIG. 5a-5c illustrate an injection mould for direct injection process including a mould closing member according to embodiments of the invention,

FIG. 6a-6f illustrate a cross sectioned footwear sole and examples of material applied to the sole,

FIG. 7 illustrates manufacturing processes and the application of vacuum, and

FIG. 8 illustrates the steps of a manufacturing process and the applications of vacuum.

### DETAILED DESCRIPTION

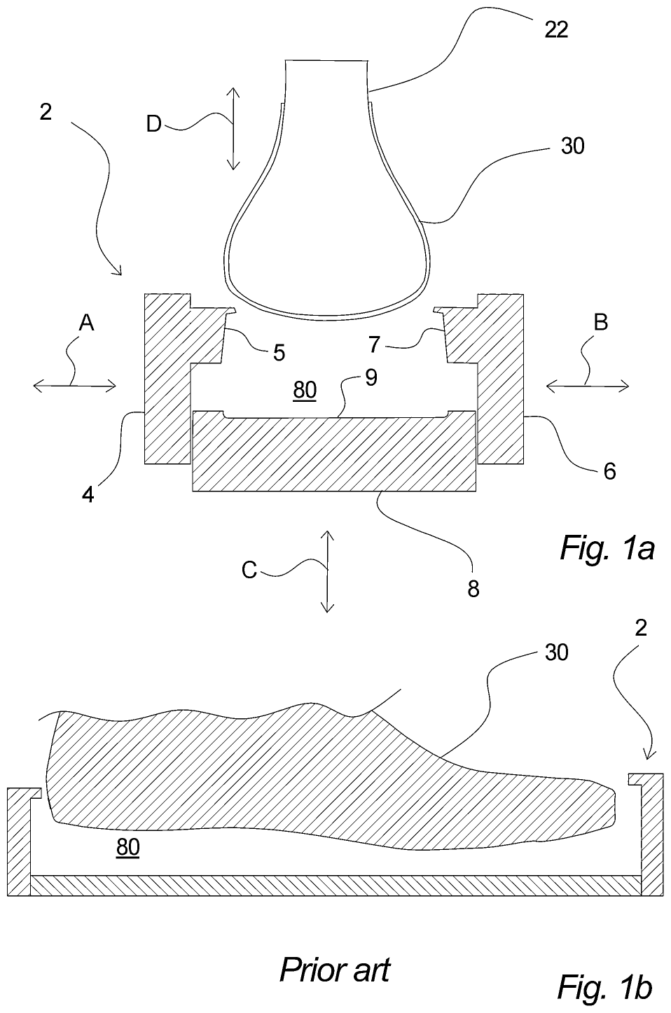

With reference to FIG. 1a a prior art moulding system will be elucidated. This figure shows schematically a mould 2 and a last 22, both seen in a cross-sectional view, which last 22 and mould 2 may be utilized for direct injection moulding of footwear according to the prior art. The mould 2 may as mentioned above have been made out of metal, for example aluminium by e.g. CNC machinery and may as shown in FIG. 1a comprise a first side mould 4, a second side mould 6 and a bottom mould 8, which are arranged in such a manner that the mould 2 may be opened and closed, e.g. by the first side mould 4 and the second side mould being able to be moved in horizontal directions as indicated with the arrows A, B and the bottom mould 8 being arranged to be moved in the vertical direction as indicated with the arrow C. As shown in FIG. 1a, the first side mould 4 and the second side mould 6 may be provided with a first side surface 5 and a second side surface 7, respectively, that have been made during e.g. CNC milling, and which generally define a desired form of a side part of a shoe sole to be moulded. Further, the bottom mould 8 is shown, which has been made during the e.g. CNC milling and which generally has a form corresponding to a desired form of the underside of the shoe sole to be moulded.

Further, it is shown in FIG. 1 a that a footwear upper 30 may be put onto the last 22 and that the last 22 with the footwear upper 30 can be moved in various directions including downwards in relation to the mould 2 as indicated with the arrow D. It will be understood that when performing such a step, it is required that the mould 2 is in an open state in order to allow the last 22 to move into the mould 2. Hereafter the mould 2 may be closed, e.g. by moving the first side mould 4 and the second side mould 6 towards each other and by moving the bottom mould 8 upwards, thus forming a mould cavity 80 between the footwear upper 30, the first side mould 4, the second side mould 6 and the bottom mould 8. The mould 2 is attached to injection moulding equipment (not shown), by means of which injection material is injected into the mould cavity 80, where it comes into contact with the first side surface 5, the second side surface 7, the bottom inner surface 9 and the bottom parts of the footwear upper 30. When the injected material has taken the shape of the mould cavity, it is being cured, bonded to the footwear upper 30.

To further elucidate a prior art mould 2, such a mould is schematically shown in FIG. 1b in the longitudinal direction of a piece of footwear being manufactured by a DIP production. The figure shows a footwear upper 30 positioned in an injection mould 2 and when the injection mould is closed forming a mould cavity 80 between the footwear upper 30 and the injection mould. The mould 2 is attached to injection moulding equipment (not shown), by means of which injection material is injected into the mould cavity 80.

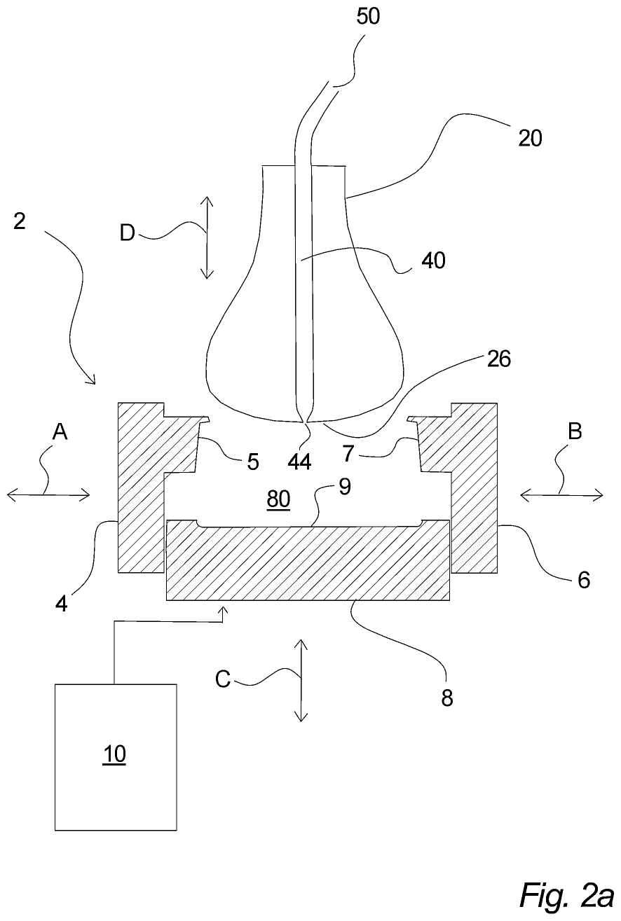

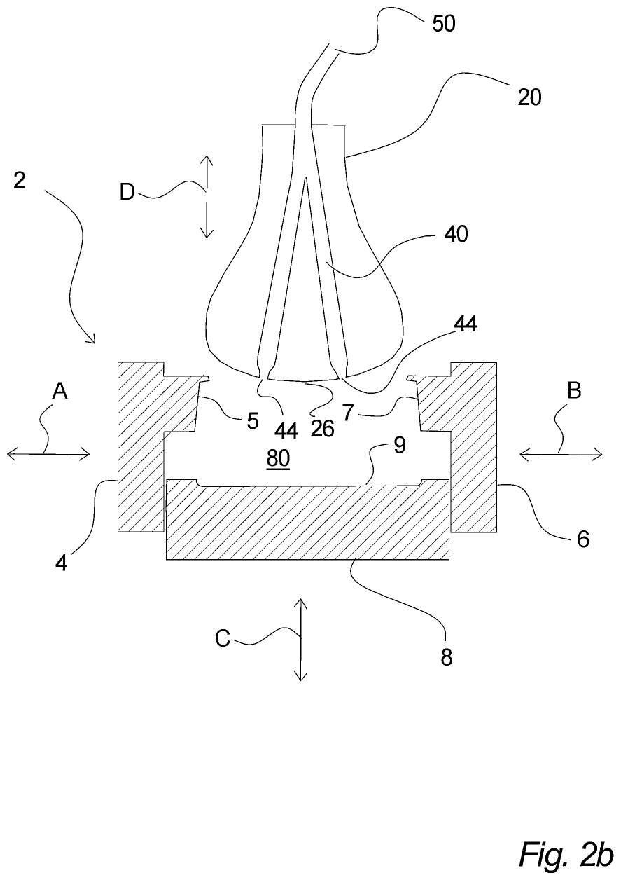

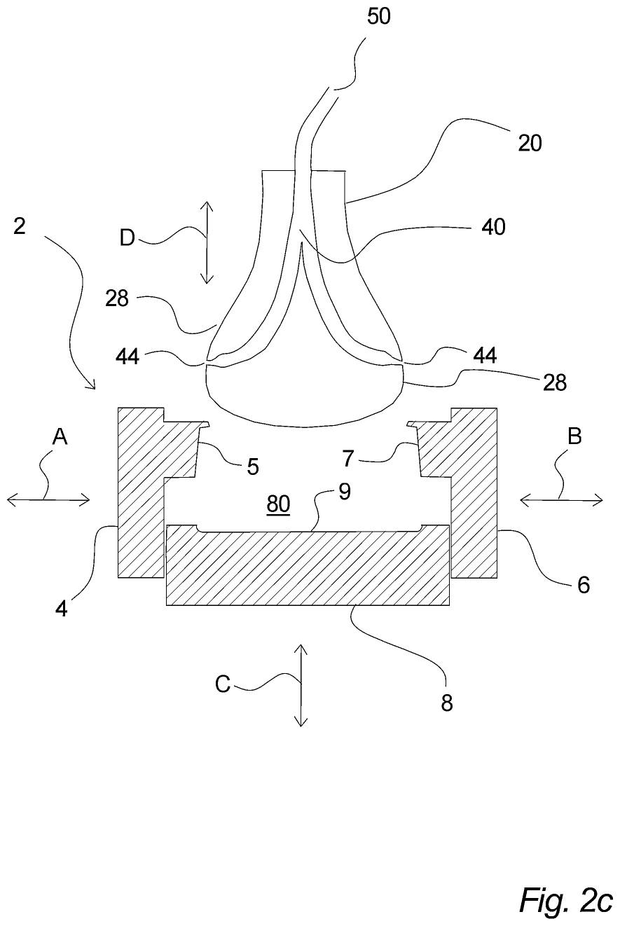

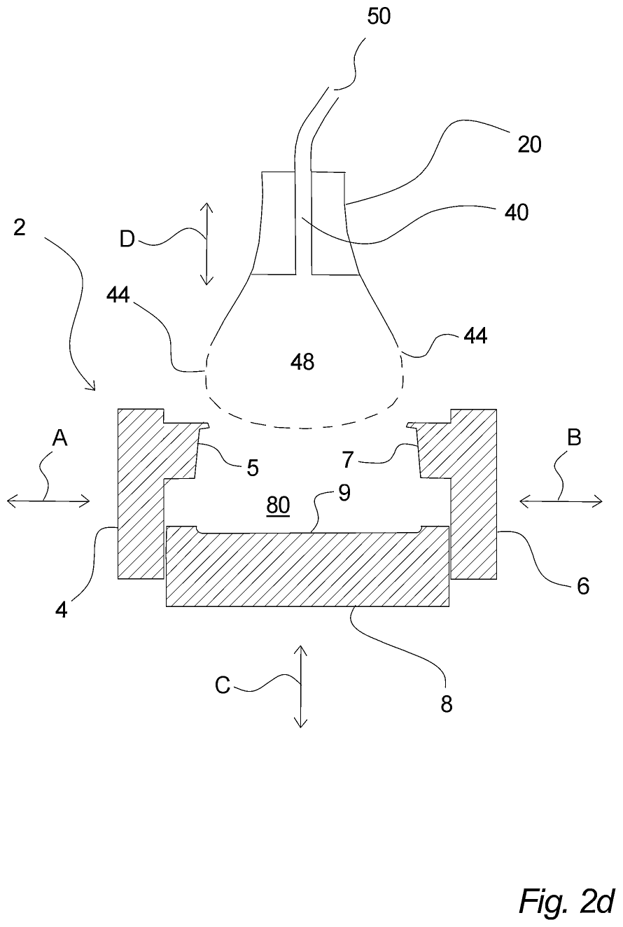

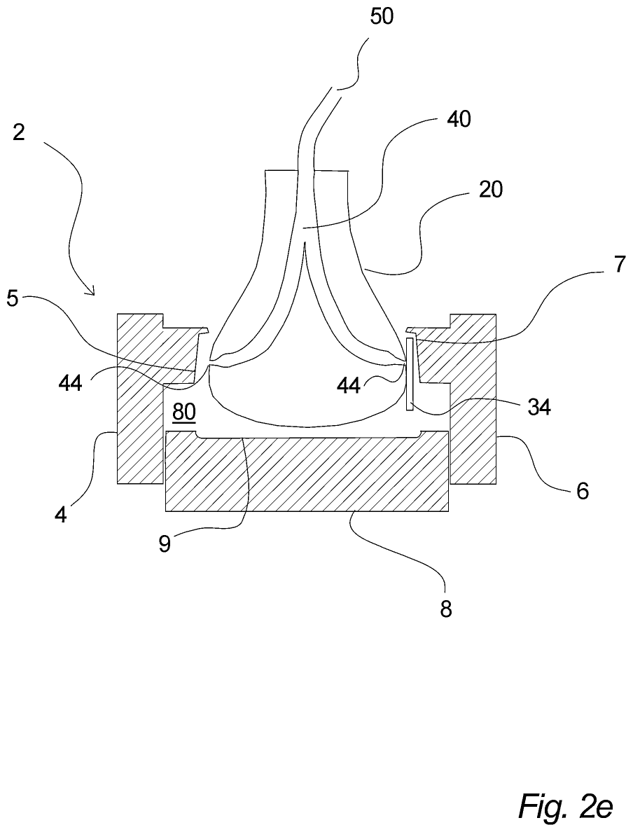

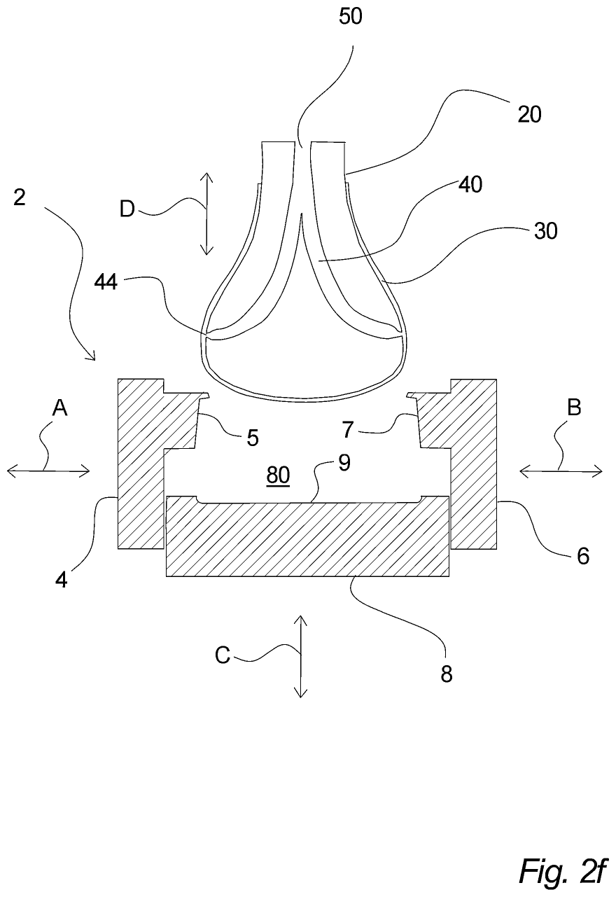

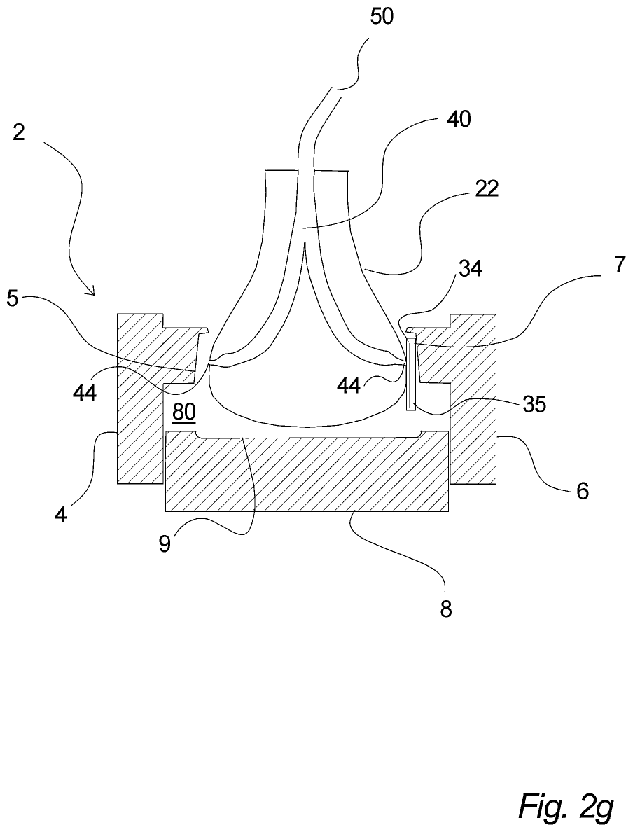

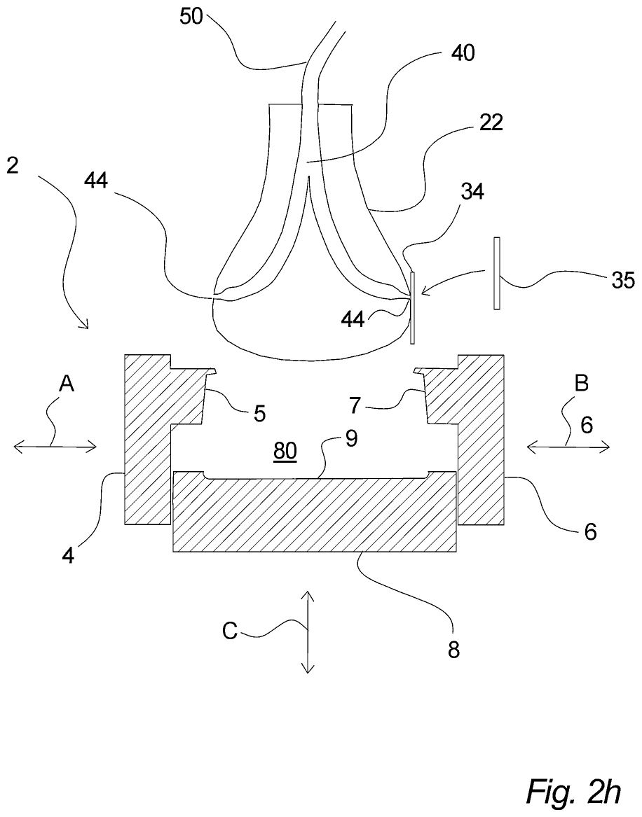

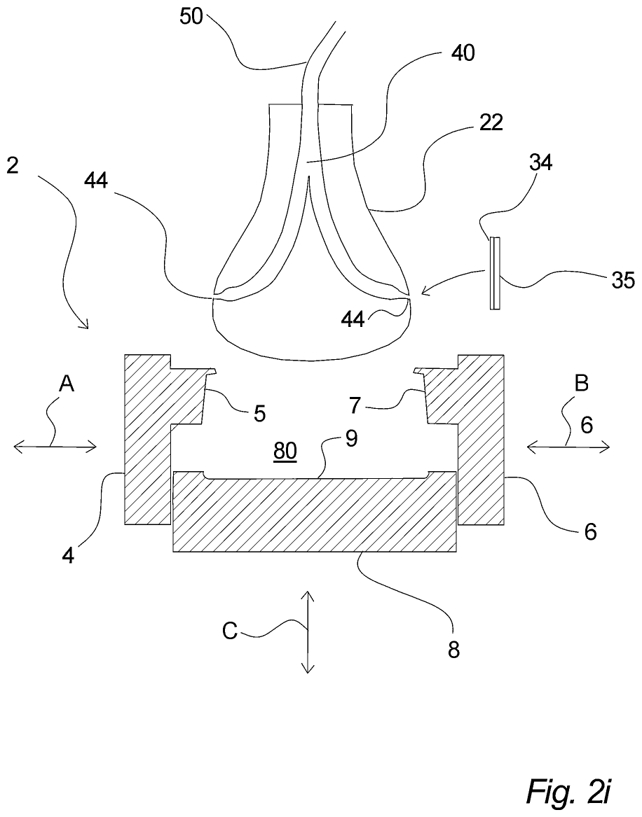

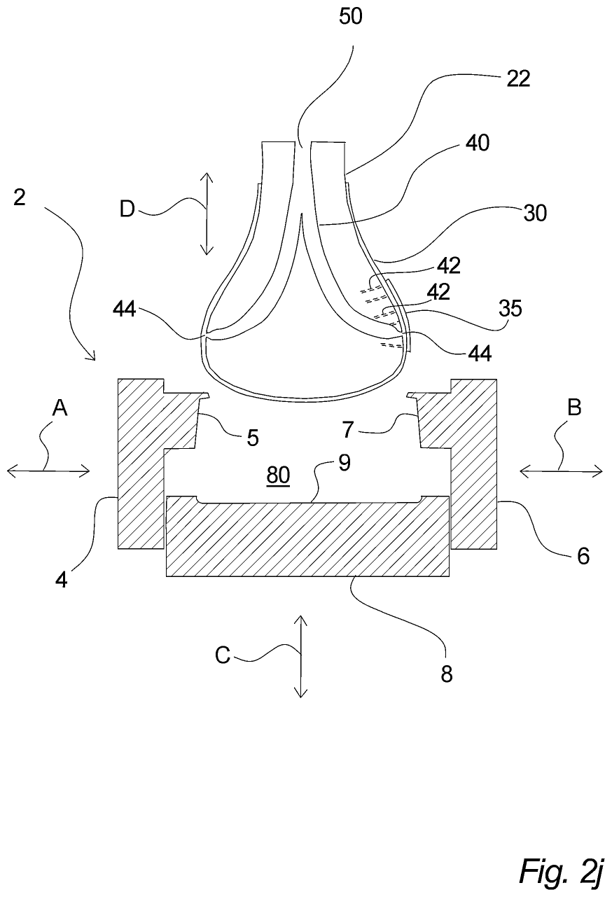

With a view to the prior art as generally described above as background art, embodiments of the present invention will be explained in the following. Thus, further details of the mould closing member and the moulding process will be understood from the following, wherein a mould closing member and the moulding process will be elucidated in connection with the FIGS. 2-8 that illustrate direct injection equipment and a direct injection process as utilized in connection with the present disclosure.

FIG. 2a shows a moulding system according to embodiments of the invention. This figure shows schematically a mould 2, which mould comprises a first side mould 4, a second side mould 6 and a bottom mould 8, and a mould closing member 20, which mould closing member 20 comprises a vacuum channel 40, vacuum supply 50 and a vacuum opening 44 seen in a cross-sectional view. The vacuum channel 40 and vacuum opening 44 are, in this example, located on the ground facing surface side of the mould closing member 20.

The mould 2 and mould closing member 20 may be utilized for direct injection moulding of a footwear according to embodiments of the invention.

Further, it is shown in FIG. 2a that the mould closing member 20 may comprise a vacuum channel 40 and a vacuum opening 44, which vacuum channel 40 may be connected to a source of vacuum. This vacuum source may be a vacuum pump, a vacuum tank, etc. wherein furthermore components may be incorporated for e.g. maintaining a stable supply, for regulating the vacuum, etc. Also, it is noted that the vacuum may be adjustable, e.g. in order to achieve vacuum within certain ranges, e.g. from 40% to 75% or the like, which may for example be desirable when changing from one type of upper material to another, e.g. to a more rigid material or to a softer material. Even further, it should be mentioned that the vacuum source may be configured for supplying vacuum to additional mould closing members, e.g. lasts, for example in case a plurality of footwear moulding systems are assembled in e.g. a carrousel system.

According to embodiments of the invention, the mould closing member may comprise one or more vacuum channels.

The mould closing member 20 may have been made out of metal, for example aluminium by e.g. CNC machinery and/or the mould closing member may comprise a polymer according to embodiments of the invention.

The mould 2 may as shown in FIG. 2a comprise a first side mould 4, a second side mould 6 which are arranged in such a manner that the mould 2 may be opened and closed, e.g. by the first side mould 4 and the second side mould 6 being able to be moved in horizontal directions as indicated with arrows A, B and by the bottom mould 8 being arranged to be moved in the vertical direction as indicated with the arrow C.

The mould 2 may be attached to injection moulding equipment 10 (as schematically illustrated in FIG. 2a), by means of which injection material is injected in the mould cavity 80. Here, the injected material will contact the surface of the mould cavity 80, the first side surface 5, the second side surface 7 and the bottom inner surface 9 during the direct injection processing. When the injected material has taken shape of the mould cavity, it is being cured. It will be understood that injection moulding equipment 10 as mentioned here and schematically illustrated in FIG. 2a will be utilized in connection with the various embodiments of the invention.

FIG. 2b shows corresponding to FIG. 2a, a schematic example of a moulding system in accordance with the present disclosure. Thus, a mould 2 and a mould closing member 20, which mould closing member 20, in this example, comprises a vacuum supply 50, two vacuum channels 40 and two vacuum openings 44 seen in a cross-sectional view. The vacuum channels 40 and vacuum openings 44 are, in this example, located on the ground facing surface side 26 of the mould closing member 20.

The application of one, two or more vacuum channels and openings located and facing the ground facing surface 26 may be for e.g. an attachment of a footbed or sole piece during a direct injection process.

FIG. 2c shows corresponding to FIGS. 2a-2b, a schematic example of a moulding system in accordance with the present disclosure. Thus, a mould 2 and a mould closing member 20, which mould closing member 20, in this example, comprises a vacuum supply 50, two vacuum channels 40 and two vacuum openings 44 seen in a cross-sectional view. The vacuum channels 40 and vacuum openings 44 are, in this example, located on the side facing surface side 28 of the mould closing member 20.

The application of one, two or more vacuum channels and openings located and facing the side facing surface 28 may be for e.g. an attachment of a footwear upper, a piece of upper etc. during a direct injection process.

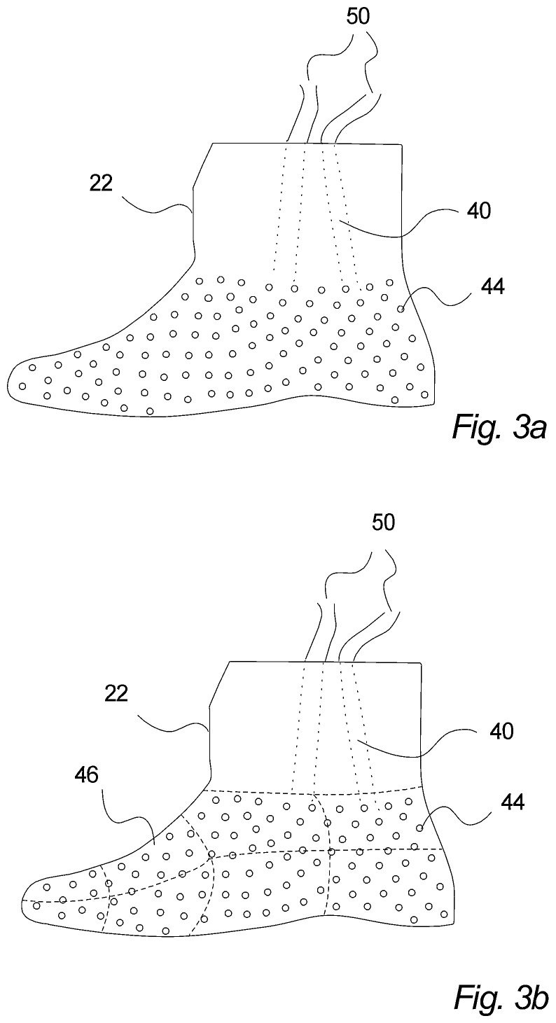

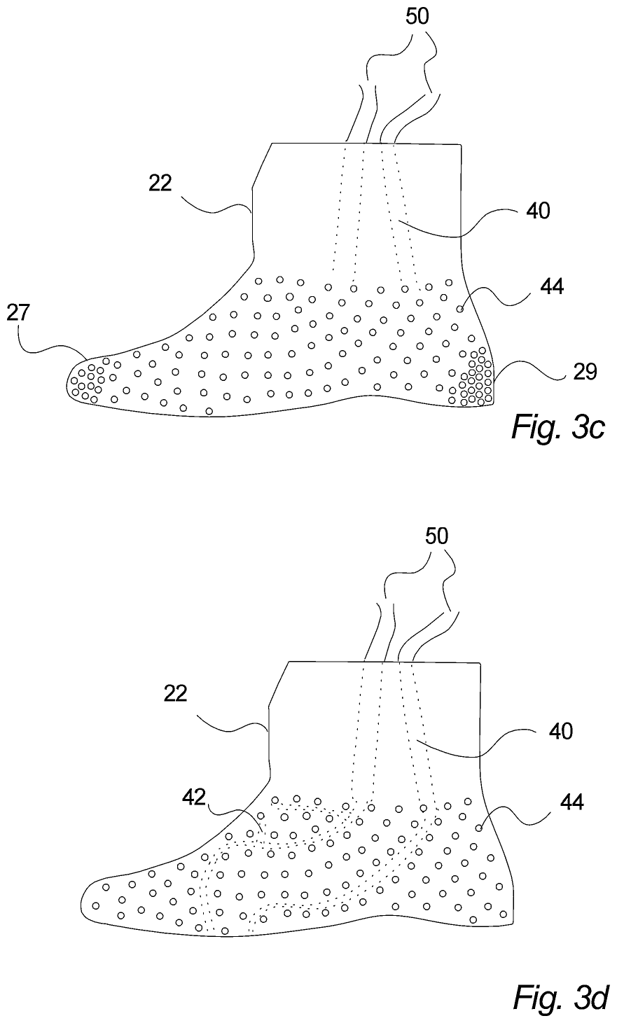

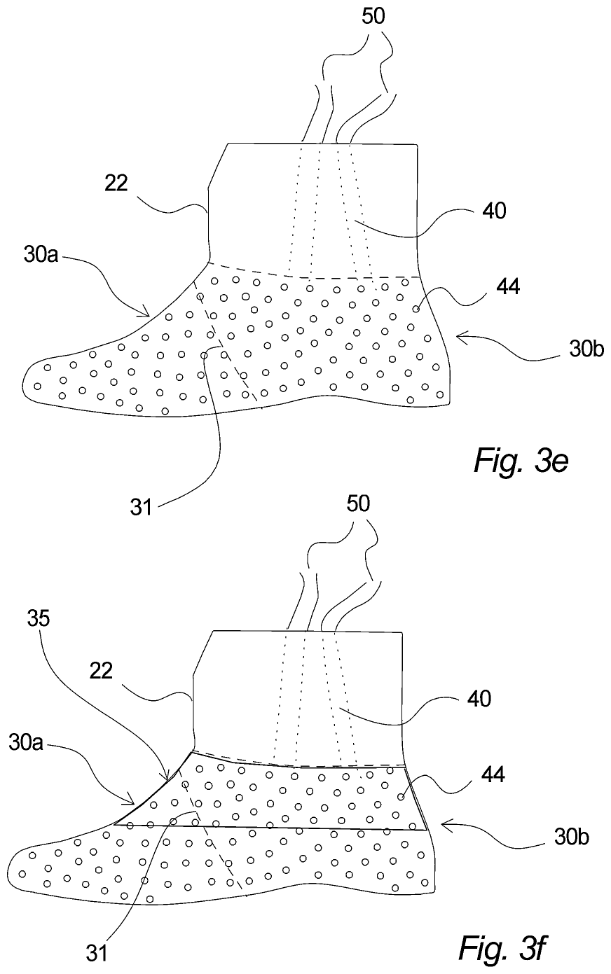

The vacuum openings on the side facing surface side 28 may cover the total surface of the mould closing member (e.g. corresponding to a footwear upper) or specific locations of the mould closing member, such as the toe surface side, the heel surface side and/or the medial and lateral surface side locations as further illustrated in FIGS. 3a-3f.

FIG. 2d shows corresponding to FIGS. 2a-2c, a schematic example of a moulding system in accordance with the present disclosure. Thus, a mould 2 and a mould closing member 20, which mould closing member 20, in this example has a cavity 48 comprising vacuum openings 44 in connection with the cavity of the mould closing member seen in a cross-sectional view. The vacuum openings 44 are, in this example, located on the side facing surface side and ground facing surface of the mould closing member 20 but may vary according to embodiments of the invention and e.g. solely be located on the ground facing surface side, the side facing surface side or more specific locations such as the toe surface side, the heel surface side and/or the medial and lateral surface side locations.

The mould closing member 20 may be a last 22, a dummy last 24 or similar constructions and will be further elucidated in the following examples.

In general, the schematic examples of a moulding system, in accordance with the present disclosure, should be understood as examples and thus various constructions, in particular regarding the mould closing member, may be regarded. Hence, the vacuum supply, vacuum channels and/or vacuum openings may be understood as one, two or several individually or connected members.

FIG. 2e shows corresponding to FIGS. 2a-2d, a schematic example of a moulding system in accordance with the present disclosure. This figure shows schematically a mould 2, which mould comprises a first side mould 4, a second side mould 6 and a bottom mould 8, and mould closing member 20, which mould closing member 20 comprises vacuum channels 40, vacuum supply 50 and vacuum openings 44 seen in a cross-sectional view. The figure further shows an insert 34 on the side surface of the mould closing member that may be attached to the side surface by the vacuum from the vacuum openings 44. The insert 34 may continue above the sole and it is noted that these inserts 34 may be made in all types of material that are bonding with the material being injected, e.g. polyurethane or other suitable material. Also, it is noted that one or more of these inserts 34 may be placed in different places in the sole, e.g. at the toe, at the heel, at the side e.g. the inside or the outside. Thus, it will be understood that such one or more inserts 34 may be bonded to the footwear construction by the injected material, e.g. midsole or outsole material, once cured.

FIG. 2f shows corresponding to FIGS. 2a-2e, a schematic example of a moulding system in accordance with the present disclosure. The figure shows that a footwear upper 30 may be put onto the mould closing member, here exemplified as a last 22.

The upper may be put onto the last as one piece of upper, however, it may also be more than one piece of upper put onto the last. When the upper or pieces of upper has been positioned on the mould closing member, the mould 2 may be closed, thus, forming a mould cavity 80 between the footwear upper 30, the first side surface 5, the second side surface 7, and the bottom mould 9, whereafter injection material is injected into the mould cavity 80, thereby attaching the upper or pieces of upper to the sole. When the injected material has taken the shape of the mould cavity, it is being cured. The individual pieces of upper may subsequently be attached by being connected along at least part of adjoining edges forming one piece of upper, e.g. by gluing and/or stitching.

FIG. 2g shows corresponding to FIGS. 2a-2e, a schematic example of a moulding system in accordance with the present disclosure. The figure shows that the part e.g. an insert 34 that is held by the vacuum may be provided with a protection foil or tape 35.

The protection foil 35 or protection tape may be of any material and serves the purpose of protecting the part(s) that is/are held by the vacuum, e.g. a footwear upper and/or insert from getting suction marks on the material from the vacuum openings.

The protection foil may also be used to optimize and tighten a material e.g. if the vacuum is used to hold a piece of textile, woven material, etc. that is more or less air permeable. It is noted that the protection foil 35 may then be fixed to the e.g. textile before applying a vacuum supply. Various methods of applying the protection foil 35 will be illustrated in the following.

FIG. 2h shows, corresponding to FIGS. 2a-2g, a schematic example of a moulding system in accordance with the present disclosure, wherein it is illustrated a manner of applying a protection foil 35 in connection with a footwear part such as an insert 34. Here, it is shown that the mould closing member, e.g. a last 22 is positioned such that the e.g. insert 34 may be placed on the last 22 while vacuum is applied to the respective vacuum openings 44, whereafter the protection foil 35 is placed on the insert as illustrated with the arrow. In case the insert 34 is permeable, the vacuum from the vacuum openings may serve to attach the protection foil 35 as well. If not (or in addition), an adhesive may be used, e.g. pre-applied to one side of the protection foil 35. When the protection foil 35 has been applied, it will serve to protect the insert 34 from markings from the vacuum openings, e.g. since the vacuum will be evened out along the area of the insert, in case the insert is permeable, and/or since the protection foil 35 will serve to stiffen the insert 34, in particular when an adhesive is applied between the insert 34 and the protection foil 35. Once applied to the last 22, the mould may be closed and injection material may be injected and cured. After opening of the mould, the protection foil 35 may be removed, while the insert 34 will be bonded to the footwear by the injected material of e.g. a sole part.

FIG. 2i illustrates a scenario corresponding to FIG. 2h, but wherein it is illustrated that the protection foil 35 has been applied to the insert 34 in advance, e.g. by having the two parts being connected with an adhesive or the like. Hence, when vacuum has been applied to the vacuum openings of the last 22, the two parts, i.e. the insert 34 and the protection foil 35 can be positioned on the surface of the last 22 with the insert 34 placed onto the last. As described in connection with FIG. 2h, the protection foil 35 will serve to protect the insert 34 from markings from the vacuum openings 44 and will ensure that the insert 34 is drawn closely to the surface of the last. The moulding is hereafter performed as described above, with the protection foil 35 being removed after the injection material has been cured.

FIG. 2j illustrates a scenario corresponding to e.g. FIG. 2f, wherein it is illustrated that a footwear upper 30 has been lasted on a mould closing member 20, e.g. a last 22, and wherein vacuum is applied to vacuum openings 44 via vacuum channels 40 and possibly vacuum sub-channels 42 (as illustrated with dash lines) to facilitate the fitting and correct positioning of the footwear upper. In FIG. 2j, it is illustrated that one or more protection foils 35 has/have been positioned on the outer side of the footwear upper. As described above, the one or more protection foils 35 may be held by vacuum, e.g. in case the footwear upper is permeable, and/or an adhesive or the like may be applied. As it will be understood, the one or more protection foils 35 may serve to protect the footwear upper 30 from markings from the vacuum openings, e.g. since the vacuum will be evened out along the area of the protection foil, in case the footwear upper is permeable, and/or since the protection foil 35 will serve as a strengthening means to the footwear upper during vacuum, in particular when an adhesive is applied between the footwear upper 34 and the protection foil 35. The protection foil 35 is removed after moulding of the footwear.

FIG. 3a shows a schematic example of a mould closing member, here exemplified as a last 22, in accordance with the present disclosure. Thus, a mould closing member 20, which mould closing member 20, e.g. a last 22 as seen in a side view comprises vacuum supply 50, vacuum channels 40, vacuum subchannels 42 and vacuum openings 44. The vacuum openings 44 are, in this example, located on the side facing surface side and ground facing surface of the mould closing member 20 but may vary according to embodiments of the invention.

FIG. 3b shows corresponding to FIG. 3a, a schematic example of a mould closing member, here exemplified as a last 22 comprising vacuum supply 50, vacuum channels 40 and vacuum openings 44 in accordance with the present disclosure. In this example, the last is divided into sub-surfaces 46 whereby the vacuum channels 40 and vacuum openings 44 may be directed to specific locations and hereby providing various individually controllable zones.

FIG. 3c shows a schematic example of a mould closing member, here exemplified as a last 22 comprising vacuum supply 50, vacuum channels 40 and vacuum openings 44. The vacuum openings 44 are, in this example, located on the side facing surface side and ground facing surface of the mould closing member 20 but may vary according to embodiments of the invention. Furthermore, in this example, the vacuum openings 44 located in connection to the toe surface side 27 and the heel surface side 29 may be located closer and in a higher amount, hereby, being able to hold and maintain e.g. a toe cap and/or heel cap that may be manufactured in a more rigid material and thus may need more vacuum or vacuum openings to e.g. the toe cap and/or heel cap.

In general, the vacuum holes 44 may be distributed in various regions of the mould closing member and may be arranged in clusters or spaced apart evenly. The clusters of vacuum openings 44 may as examples be positioned in regions where the upper is to be fixed to the last and/or may be in positions where e.g. a footbed is fixed to the last.

FIG. 3d shows a schematic example of a mould closing member, here exemplified as a last 22, in accordance with the present disclosure. Thus, a mould closing member 20, which mould closing member 20 seen in a side view comprises vacuum supply 50, vacuum channels 40, vacuum subchannels 42 and vacuum openings 44. The vacuum openings 44 are, in this example, located on the side facing surface side and ground facing surface of the mould closing member 20 but may vary according to embodiments of the invention. Further in this figure, examples of subchannels 42 are shown, and should generally be understood as one or more further vacuum channels that are connected to a vacuum channel 40, e.g. as a branching out of vacuum channels. A subchannel 42 may have a smaller diameter than vacuum channel 40.

The vacuum openings 44 are exemplified as circular, however, the vacuum openings may of course have any suitable sizes and shapes e.g. squares, tringles etc.

FIG. 3e corresponds to the last illustrated in FIG. 3a, but in FIG. 3e it is further shown in a schematic manner that a lasted footwear upper comprises two or more separate parts, e.g. the footwear upper parts 30a and 30b that as illustrated with dash lines have been applied to the last 22 in such a manner that they meet at adjoining edges 31, e.g. overlapping or edge to edge.

As further illustrated in FIG. 3f, one or more protection foils 35 may be applied on the outside of the footwear upper parts 30a and 30b, such that the one or more protection foils 35 may serve to protect the upper materials from markings from the vacuum openings 44 and to facilitate the positioning of the footwear upper parts 30a and 30b, but wherein as illustrated the one or more protection foils 35 may serve to ensure that the footwear upper parts are kept in the correct mutual positions, e.g. along the adjoining edges 31, e.g. in case a protection foil covers such an adjoining edge 31.

In FIG. 3f it is shown that only part of the footwear upper is covered by protection foil 35, but it will be understood that protection foil may be applied to more or less of the footwear upper, e.g. while vacuum is applied, during moulding, etc.

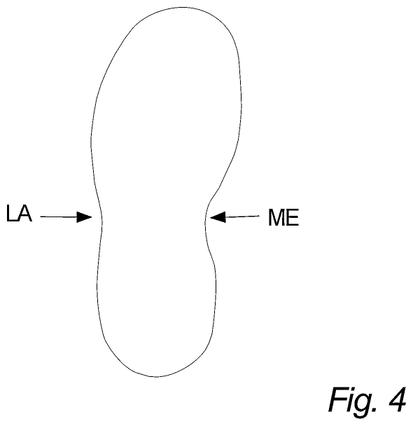

FIG. 4 illustrates a footwear or sole from above showing the locations of the medial ME and lateral LA positions on the footwear according to embodiments of the invention. Medial ME and lateral LA should be understood as the anatomical terms of location, wherein medial is the location toward the midline of the body and lateral refers to the side of the body that is away from the midline.

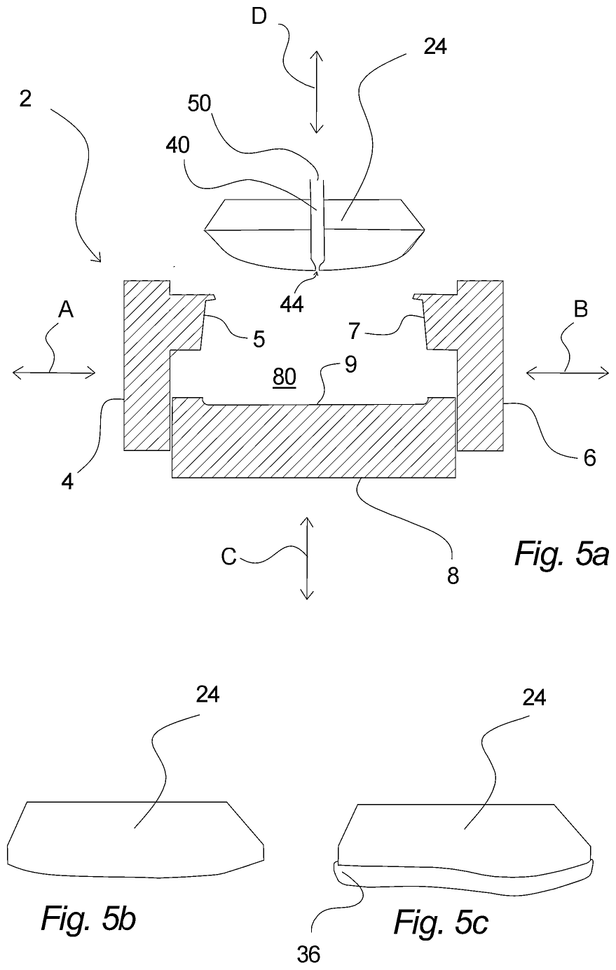

FIG. 5a illustrates a mould for direct injection process including a mould closing member according to embodiments of the invention.

The figure is a variant of FIGS. 2 and 3, wherein the difference lies in the closure of the mould. FIG. 5a-5c illustrates a mould closing member 20 exemplified as a so-called dummy last 24 for closing of the mould 2 during direct injection process to keep the direct injection material e.g. PU in the form during the process. The mould closing member, e.g. a dummy-last 24, may be a loose or separate part that can be applied to the mould prior to the direct injection process or the mould closing member may also be a part of the mould.

By using a dummy last 24 as a mould closing member, the montage process differs from the conventional process by an absent lasting process of the upper on the machine last. Instead, the sock 36 (as shown in FIG. 5c) is attached to the dummy last.

FIG. 5b-5c illustrate a side view of the mould closing member, e.g. dummy last 24, where 5b shows an example of a dummy last 24 and 5c shows an example of a dummy last 24 including a sock 36.

The sock 36 may be manufactured in any material but preferably in a soft material that can tolerate the temperatures during a direct injection process. The material of the sock may e.g. be leather, textile or similar material and should be easy to remove after the direct injection process by itself or with the application of a second material. The sock may further be provided with strings or similar to fix the sock to the closing member e.g. a last 22 or a dummy last 24. The closing member may also be provided with e.g. vacuum to fix the sock to the closing member.

The sock 36 may further be provided with padding, other layers and/or additional materials such as e.g. EVA, PU, cork or the like making up a footbed. However, a footbed may also be without the sock and attached directly to the dummy last 24 or at least touching the dummy last during manufacture.

An advantage of providing the closing member, e.g. a last 22, with a sock 36 is to mediate a closure of the mould. Further and highly advantageously the sock may also be a part of the sole during a direct injection process.

The terms sock and cover may be used interchangeably.

A footbed in the present context, unless otherwise noted, may thus e.g. include both insole (if present), different sole members and/or layers. In particular embodiments of the invention further layers or members may be attached to the footbed or the layers may be included within the footbed.

Hereby, several variations of the order of the materials of the footbed are possible either as a single material or as sandwich constructions of materials.

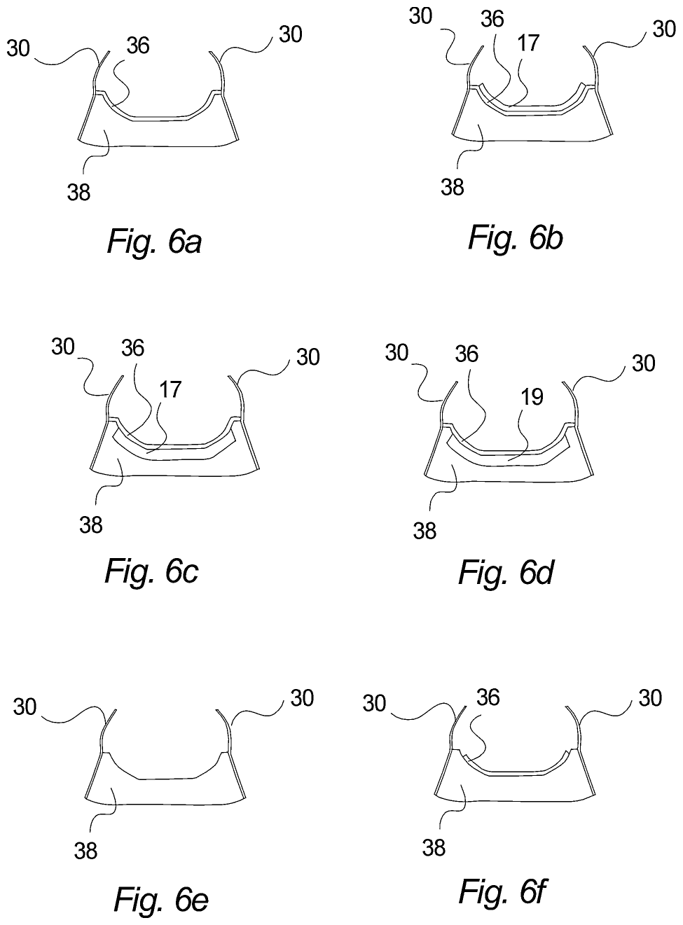

An example could be a sock placed on a dummy last and during a direct injection process, the sock would then come into contact with the sole material e.g. PU. The sock could further be provided with patterns to provide the sole with e.g. text or different aesthetic appearances on the upper facing surface of the sole. In such case, the sock is not a part of the sole and removed from the sole after the direct injection process and an example hereof is shown in FIG. 6e. Slip-agent may be added to this process to provide the intended removal of the sock from the footbed.

The sock 36 may also become a part of the sole as a footbed during the direct injection process and thereby provide the upper facing surface with a comfortable surface for the user of the footwear and e.g. more wear-resistant soles. In such case, the sock is not removed from the sole and a trimming process may also be needed.

FIG. 6a-6f illustrate a cross sectioned sole 38 and different examples of the order of the materials of the footbed. These should only be understood as examples and the order may be different from the shown examples and the footbed may also contain other materials than in the shown examples.

FIG. 6a shows an example of the sole 16 provided with a sock 36.

FIG. 6b and FIG. 6c show examples of sandwich constructions of the footbed where an additional layer 17 and/or additional members 17 can be positioned on the sock 36 either in contact with the sole upper surface as shown in FIG. 6b, and/or as shown in FIG. 6c in contact with the sock 36 and sole 38. The additional layer 17 can be any material, such as e.g. EVA, PU, cork or the like, have various thickness and there may be several additional layers. An additional layer may also be a gasket or similar (not shown) with the advantage of making a separation of the different layers or keeping a shape of a layer e.g. foam. As shown in FIG. 6b and FIG. 6c, the additional layer and/or additional member may both be regarded as a part of the footbed either by being included within the footbed as in FIG. 6c or attached onto the footbed as disclosed in FIG. 6b.

The constructions may also include foam 19 that e.g. can be positioned between the sole 38 and the sock 36 as shown in FIG. 6d and hereby provide a softer and more comfortable sole. The foam can be positioned on the sock 36 either in contact with the sole upper surface and may vary in thickness and also have several layers. This layer 19 may also be regarded as an additional layer, but in the present context this layer is regarded as part of the footbed.

The sock 36 may only extend partially along the length/width of the sole 38 as shown in FIG. 6f.

A footbed should be understood as the part of the shoe that runs under the bottom of the foot to the sole material. It may have layers of construction and structural elements added for e.g. better fit and comfort.

Foam should be understood as any types of foam suitable for footwear and may be a soft plastic that is filled with air bubbles. The properties of different foams are created using different types of material (e.g. latex, PU, EVA, etc), controlling the size and controlling the character of the air bubbles.

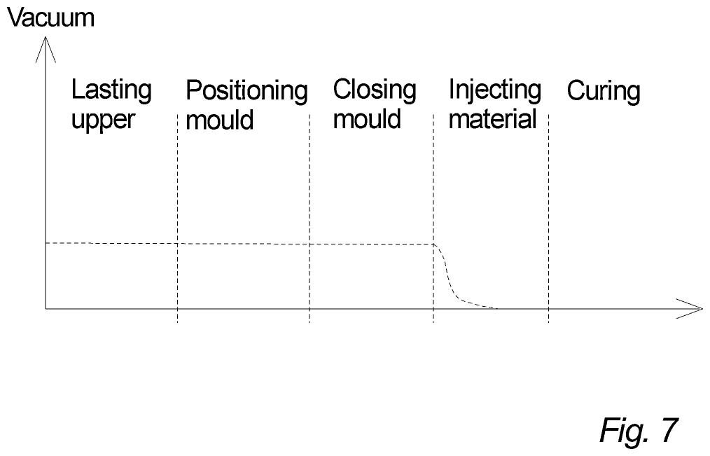

FIG. 7 illustrates an example of manufacturing processes, e.g. process steps such as “lasting upper”, “positioning in mould”, “closing mould”, “injecting material” and “curing” in relation to the application of vacuum. “Lasting upper” should be understood as the footwear upper may be put onto the last as one piece of upper, however, it may also be more than one piece of upper put onto the last. “Positioning in mould” should be understood as the process of positioning a last comprising the upper is directed and positioned into the injection mould. “Closing mould” should be understood as the process where the last is positioned for injection moulding in the mould and the mould is closed, as also described in FIG. 2. Here, a first side mould 4, a second side mould 6 are arranged in such a manner that the mould 2 may be closed, e.g. by the first side mould 4 and the second support side mould 6 being able to be moved in horizontal directions as indicated with arrows A, B and by the bottom mould 8 being arranged to be moved in the vertical direction as indicated with the arrow C. “Injecting material” should be understood as the process of injecting moulding material e.g. PU into the mould e.g. via an injection channel or by casting. “Curing” should be understood as the process of curing or hardening of the injection material and ensures that the material maintains its shape after the material has cured.

Vacuum supply may be applied before and during the lasting process of the upper whereby vacuum holds e.g. the upper or upper parts positioned during lasting and positioning the lasted upper into the mould. After the mould is closed and prepared for the injection process, the vacuum supply may be turned off as the upper may be sufficiently fixed by the moulds.

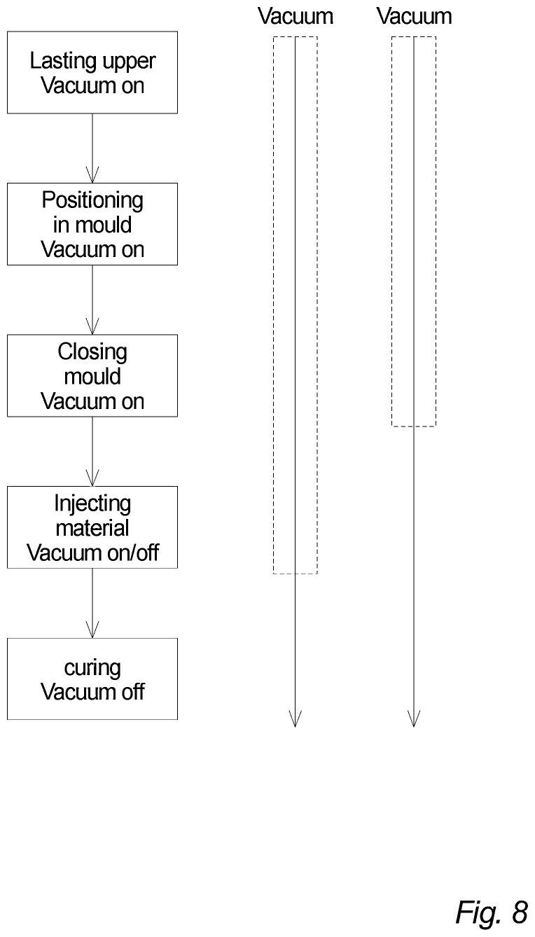

FIG. 8 illustrates an example of steps during manufacturing of a footwear according to embodiments of the invention and further illustrates examples of when vacuum is supplied. Vacuum supply may be applied during lasting upper, positioning in mould, closing mould and injecting material. The latter is optional and vacuum supply may not be applied during the step of injecting. In fact, it may be an advantage to shut off the vacuum supply before the step of injecting moulding material and thus avoid moulding material in the vacuum openings.

In these examples, a footwear upper and thus lasted upper is used as an example of the process. However, this may of course also apply to any embodiments according to the invention, e.g. a footbed, a sock etc.

During the step of injection moulding, there may be an excess of moulding material and air and/or other gasses that are developed during the process and these are advantageously released assisted by the construction of the mould e.g. through the joints between the side moulds.

### LIST OF REFERENCE NUMBERS

2 Mould
4 First side mould
5 First side surface
6 Second side mould
7 Second side surface
8 Bottom mould
9 Bottom inner surface
10 Injection moulding equipment
17 Additional layer/member
19 Foam
20 Mould closing member
22 Last
24 Dummy last
26 Ground facing surface side
27 Toe surface side
28 Side facing surface side
29 Heel surface side
30 Footwear upper
30a, 30b Footwear upper parts
31 Adjoining edge
32 Footbed
34 Insert
35 Protection foil
36 Sock
38 Sole
40 Vacuum channel
42 Vacuum sub-channel
44 Vacuum openings
46 Sub-surface
48 Mould closing member cavity
50 Vacuum supply
80 Mould cavity
LA Lateral side
ME Medial side

1. A footwear moulding system for direct injection production of footwear, said moulding system comprising
an injection mould,
a mould closing member,
wherein the mould closing member comprises at least one vacuum channel and wherein the at least one vacuum channel is connected directly or indirectly to at least one vacuum opening on the surface of the mould closing member,
wherein said mould closing member is configured for positioning at least part of a footwear upper during at least part of a direct injection production process, said at least part of a footwear upper being at least partly adhered to the mould closing member by vacuum effected by said at least one vacuum opening.

2. The footwear moulding system according to claim 1, wherein the mould closing member is a last.

3-5. (canceled)

6. The footwear moulding system according to claim 1, wherein the at least one vacuum channel is branched out in multiple sub-channels and wherein the sub-channels are connected to vacuum openings on the surface of the mould closing member.

7. The footwear moulding system according to claim 6, wherein the surface of the mould closing member comprises sub-surfaces and wherein the sub-channels are connected to vacuum openings on said sub-surfaces.

8. (canceled)

9. The footwear moulding system according to claim 1, wherein the mould closing member comprises vacuum openings on at least one of a lateral side (LA), a medial side (ME), a ground facing surface side.

10.-11. (canceled)

12. The footwear moulding system according to claim 1, wherein the footwear moulding system further comprises injection moulding equipment for performing direct injection moulding of a sole part in said injection mould.

13. (canceled)

14. The footwear moulding system according to claim 6, wherein a direct injection material is polyurethane (PU), thermoplastic polyurethane (TPU), polyvinyl chloride (PVC) or thermoplastic rubber (TR).

15. The footwear moulding system according to claim 1, wherein a diameter of the vacuum opening is smaller than a diameter of the vacuum channel.

16.-17. (canceled)

18. The footwear moulding system according to claim 1, wherein the system further comprises at least one piece of protection foil to cooperate with one or more of said at least one vacuum opening.

19. The footwear moulding system according to claim 18, wherein said at least one piece of protection foil is configured for being applied at one side of at least one footwear part and wherein the opposite part of the footwear part is at least partly adhered to the mould closing member by vacuum effected by said at least one vacuum opening.

20.-21. (canceled)

22. A method for manufacturing a footwear, said method comprising steps of providing a moulding system comprising:
an injection mould, and
a mould closing member,
wherein the mould closing member comprises at least one vacuum channel and wherein the at least one vacuum channel is connected directly or indirectly to at least one vacuum opening on the surface of the mould closing member,
wherein said method further comprises steps of:
applying a source of vacuum to said at least one vacuum channel,
positioning at least part of a footwear upper on said mould closing member, said at least part of a footwear upper being at least partly held in place by said vacuum,
positioning said mould closing member with said at least part of a footwear upper in relation to said injection mould,
closing said injection mould to form a mould cavity,
injecting direct injection material into said mould cavity, said mould cavity defining a sole, and
opening said injection mould upon curing for removal of the sole with said at least part of a footwear upper attached to the sole.

23. The method according to claim 22, wherein the method further comprises positioning a further part of a footwear on said mould closing member, said further part of a footwear being at least partly held in place by said vacuum.

24. The method according to a m claim 22,
wherein the at least part of a footwear upper comprises two or more individual pieces of footwear parts, and
wherein said two or more individual pieces of footwear parts are positioned and at least partly held in place by said vacuum on said mould closing member.

25. The method according to claim 22, wherein said two or more individual pieces of footwear parts, subsequent to removal of the sole with said at least part of a footwear upper, attached to the sole, are further processed to form part of the upper of the footwear.

26.-27. (canceled)

28. The method according to claim 22, wherein the method further comprises a step of applying a protection foil.

29. (canceled)

30. The method according to claim 28, wherein said protection foil is configured for being applied at one side of at least one footwear part and wherein the opposite part of the footwear part is at least partly adhered to the mould closing member by vacuum effected by said at least one vacuum opening.

31.-42. (canceled)

43. A mould closing member for direct injection production of footwear, wherein said mould closing member comprises:
at least one vacuum channel and wherein the at least one vacuum channel is connected directly or indirectly to at least one vacuum opening on the surface of the mould closing member,
wherein said mould closing member is configured for positioning at least part of a footwear upper during at least part of a direct injection production process, said at least part of a footwear upper being at least partly adhered to the mould closing member by vacuum effected by said at least one vacuum opening.

44. The mould closing member according to claim 43, wherein the mould closing member is a last or a dummy last.

45.-46. (canceled)

47. The mould closing member according to claim 43, wherein the at least one vacuum channel is branched out in multiple sub-channels and wherein the sub-channels are connected to vacuum openings on the surface of the mould closing member.

48. The mould closing member according to claim 47, wherein the surface of the mould closing member comprises sub-surfaces and wherein the sub-channels are connected to vacuum openings on said sub-surfaces.

49.-55. (canceled)
